(19) United States
(12) Patent Application Publication
(10) Pub. No.: US 2008/0078840 A1
(43) Pub. Date: Apr. 3, 2008

(54) Structure Of Memory Card

(76) Inventor: Chin-Tong Liu, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/536,684

(22) Filed: Sep. 29, 2006

(51) Int. Cl. G06K 19/06

(52) U.S. Cl. 235/492

(57) ABSTRACT

A structure of memory card is provided, including a circuit substrate, and a shell for housing and sealing the circuit substrate. A first surface of the circuit substrate includes at least a memory chip, and an opposite second surface includes an electric contact part. The shell covers and seals the circuit substrate, but exposes the electric contact part. The shell includes a metal sheet, and the metal sheet contacts the memory chip of the circuit substrate for dissipating the heat generated by the memory chip by providing a larger area contact to the cooler environment.

### FIELD OF THE INVENTION

The present invention generally relates to a memory card, and more specifically to a structure of memory card with effective heat-dissipation.

### BACKGROUND OF THE INVENTION

The conventional small-sized memory cards, such as SD card and MMC card, are usually packaged in plastic and must comply with a standard packaging specification so that they can be used for various electronic devices. As the applications grow rapidly, the demands of high capacity memory cards also increases. The reduction of memory chip size allows the packaging of more memory chips into a single memory card; hence, the increase of memory capacity. However, as the standard size of the small-sized memory card is only 32 mm×24 mm×2.1 mm, the more memory chips and control circuits are packaged, the more heat will be generated during the memory card access and operation. Because the heat may interfere with, or even damage, the memory card, the heat dissipation becomes an important issue that the design of a high capacity memory card must address.

### SUMMARY OF THE INVENTION

The present invention has been made to overcome the aforementioned drawback of conventional memory card packaging technology. The primary object of the present invention is to provide a structure of memory card with effective heat dissipation. The present invention includes at least a metal sheet on the packaged shell of memory card. The shell contacts the memory chips and can dissipate the heat generated by the memory chips through the metal sheet to the outer cooler environment. The effective heat dissipation not only prolongs the life span of the memory card, but also improves the performance of the memory card.

Another object of the present invention is to provide a structure of high capacity memory card. The structure of the present invention allows more memory chips to be packaged into a standard specification by alleviating the over-heating problems caused by high density packaging of the memory chips.

To achieve the above objects, the present invention provides a structure of memory card, including a circuit substrate, and a shell for housing and sealing the circuit substrate. A first surface of the circuit substrate includes at least a memory chip, and an opposite second surface includes an electric contact part. The shell covers and seals the circuit substrate, but exposes the electric contact part. The shell includes a metal sheet, and the metal sheet contacts the memory chip of the circuit substrate.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention;

FIG. 2 shows a schematic view of the circuit substrate of the present invention;

FIG. 3 shows a schematic view of the present invention, as viewed from the angle opposite to FIG. 1;

FIG. 4 shows a cross-sectional view of the A-A surface of FIG. 1;

FIG. 5 shows a cross-sectional view of the second embodiment of the present invention; and

FIG. 6 shows the electrical contact part of the second embodiment.

### DETAILED DESCRIPTION OF THE PREFERRED EMBODIMENTS

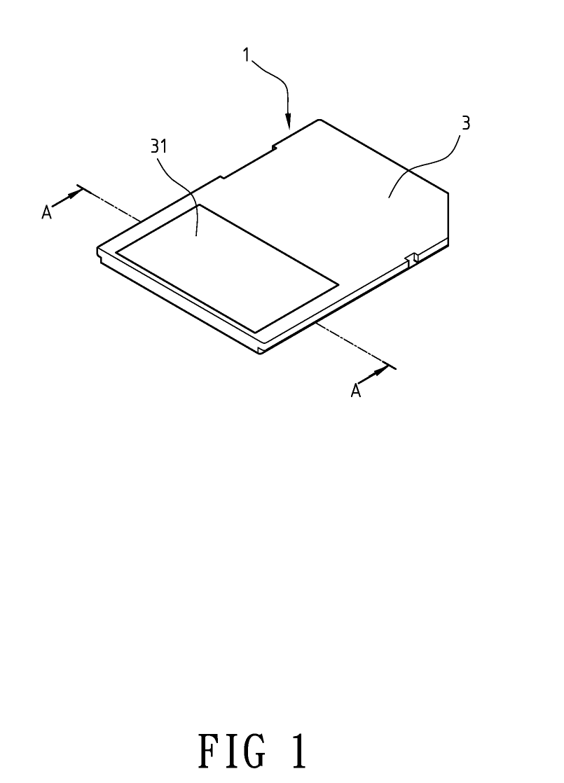

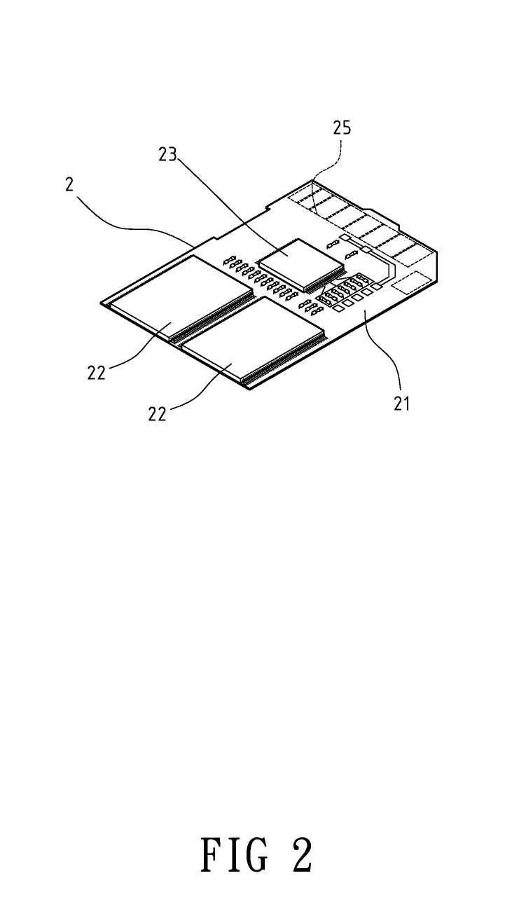

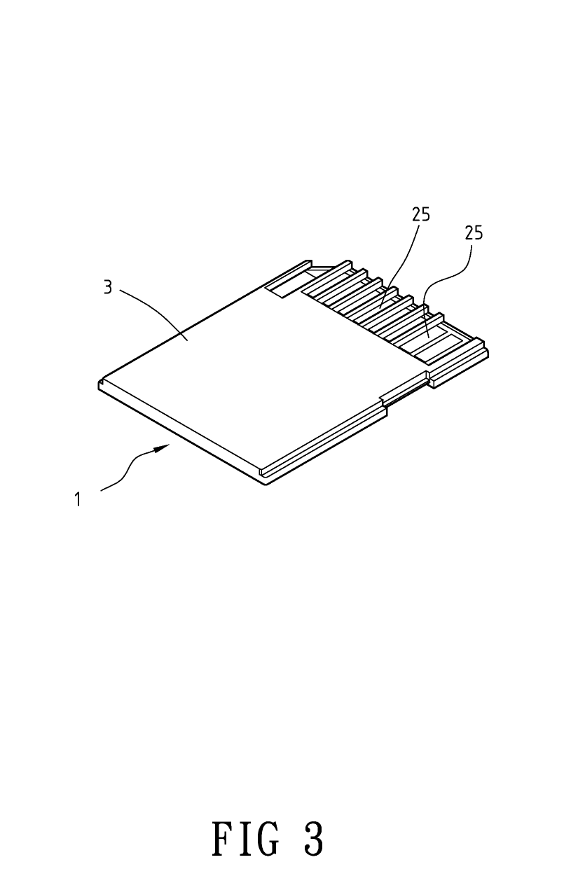

FIGS. 1 & 2 show a schematic view of a structure of memory card and a circuit board substrate of the present invention, respectively. A memory card 1 includes a circuit substrate 2, and a shell 3 for sealing circuit substrate 2 inside shell 3. A first surface 21 of circuit substrate 2 includes at least a memory chip 22, and a control chip 23. A second surface (hidden from the view in FIG. 2), opposite to first surface 21, includes an electrical contact part 25. Circuit substrate 2 further includes internal circuits for providing electrical connection to memory chip 22, control chip 23 and electrical contact part 25. Electrical contact part 25 provides electrical contact to an electronic device when memory card 1 is inserted in the electrical device. Shell 3 seals circuit substrate 2 to provide packaging and protection. Shell 3 can be made of acrylintrie-butadiene-styrene copolymer (ABS) material, or poly carbonate (PC) material. Shell 3 can be formed by injection molding to provide effective sealing and water-proof. As shown in FIG. 3, shell 3 seals circuit substrate 2, while exposing electrical contact part 25 to provide electrical connection to the electronic device.

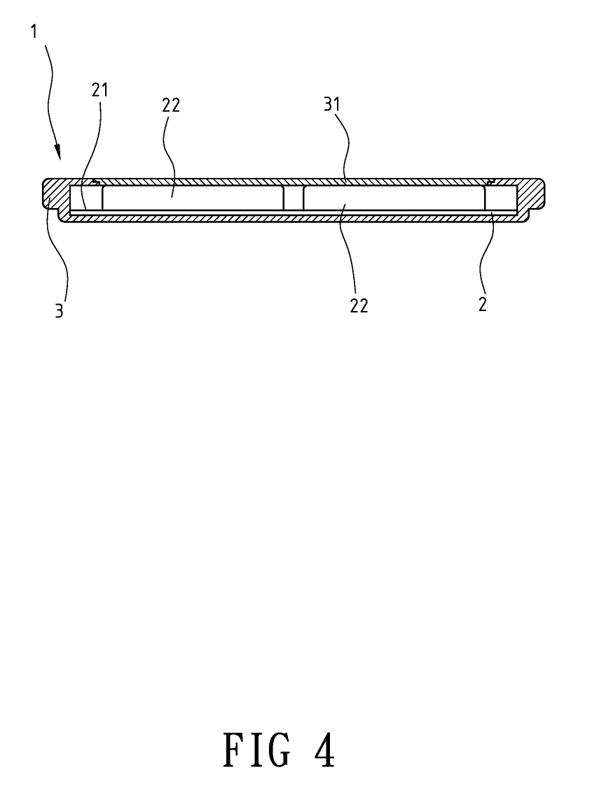

As shown in FIG. 1, shell 3 of the present invention includes a metal sheet 31 constituting an area of a surface. As shown in FIG. 4, metal sheet 31 is placed on the shell area that covers first surface 21 of circuit substrate 2. Instead of fully covers the entire surface 21, metal sheet 31 constitutes only a shell area covering memory chip 22 on surface 21. Therefore, when packaged, metal sheet 31 contacts memory chip 22 to dissipate the heat generated by memory chip 22 during access and operation. As the memory chip density increases in memory cards, the heat dissipation function provided by metal sheet 31 enables the memory cards to dissipate heat more effectively and improve the stability of the operation.

To maintain the normal operation of the memory card, metal sheet 31 of shell 3 contacts the insulating surface of memory chip 22, and stays clear of any electrical contact points, such as wire, solder points, and metal contacts, on circuit board 2 to avoid short circuit.

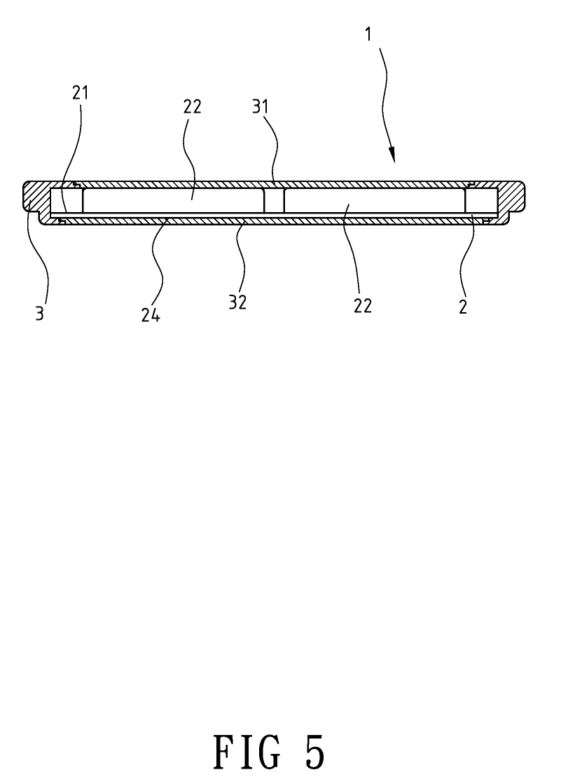

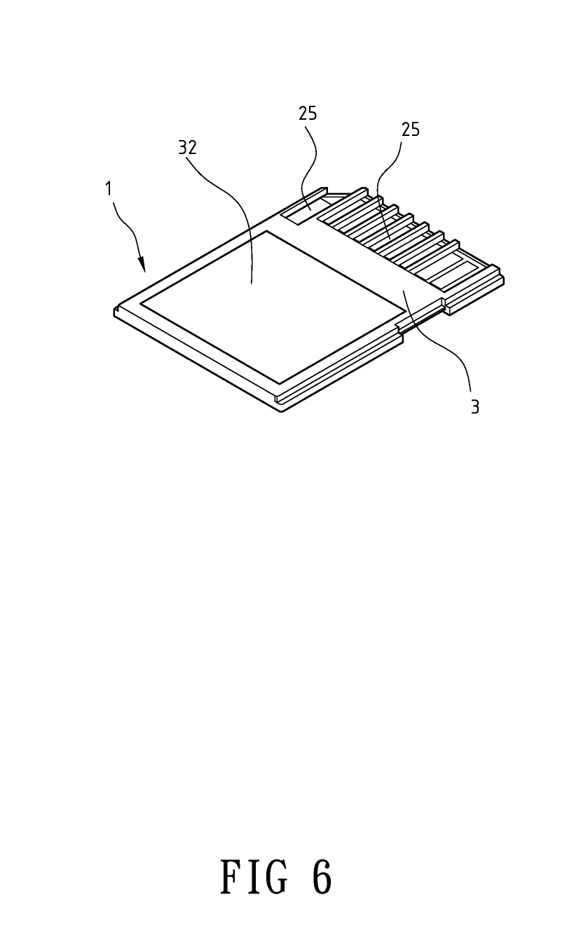

FIG. 5 shows a cross-sectional view of the second embodiment of the present invention. The difference between this embodiment and the first embodiment is the placement distribution of metal sheet 31 on shell 3. As shown in FIG. 5, two metal sheets 31, 32 are placed on the opposite surfaces of shell 3. That is, metal sheet 31, 32 cover part of the areas of first surface 21 and second surface 24, respectively. Similarly, metal sheet 32 contacts second surface 24 for heat dissipation. As shown in FIG. 6, metal sheet 32 does not directly contact electrical contact part 25 of second surface 24. Therefore, short circuit problem can be avoided. With this embodiment, the two metal sheets provide a larger area for contacting the air and dissipating the heat generated by circuit substrate 2.

In summary, the present invention includes at least a metal sheet on the shell sealing the circuit substrate. The metal sheet contacts the memory chip on the circuit substrate and effectively dissipates the heat generated by the memory chip by providing a larger contact area to the cooler environment. This feature will prolongs the life span of the memory card as well as improve the performance of the memory card.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A structure of memory card, comprising:
a circuit substrate, with a first surface having at least a memory chip, a second surface having an electrical contact part, and internal circuit for providing electrical connections to said memory chip and said electrical contact part, said first and second surfaces being on opposite side of said circuit substrate; and
a shell, for sealing said circuit substrate inside said shell, while exposing said electrical contact part of said circuit substrate, said shell having at least a metal sheet covering an area of said shell and providing contact to said memory chip for dissipating heat generated by said memory chip.

2. The structure as claimed in claim 1, wherein said metal sheet contacts the insulating surface of said memory chip

3. The structure as claimed in claim 1, wherein said metal sheet is not electrically connected to said circuit substrate.

4. The structure as claimed in claim 1, wherein said shell has two metal sheets on opposite surface covering an area of said first surface and said second surface of said circuit substrate, respectively.
